(19) United States
(12) Patent Application Publication
(10) Pub. No.: US 2026/0259411 A1
(43) Pub. Date: Sep. 3, 2026

(54) OPTICAL WAVEGUIDE COMPONENT AND AUGMENTED REALITY DISPLAY DEVICE

(71) Applicant: Goertek Optical Technology Co., Ltd., Waifang, Shandong (CN)

(72) Inventors: Rudong Wei, Shandong (CN); Yi Rao, Shandong (CN); Xiao Wu, Shandong (CN); En Zhao, Shandong (CN); Lichao Dong, Shandong (CN); Xin Cheng, Shandong (CN)

(73) Assignee: Goertek Optical Technology Co., Ltd., Waifang, Shandong (CN)

(21) Appl. No.: 18/867,583

(22) PCT Filed: Jun. 28, 2022
(86) PCT No.: PCT/CN2022/102030

§ 371 Date: Nov. 20, 2024

(30) Foreign Application Priority Data
May 24, 2022 (CN) 202210575116.2

(51) Int. Cl. G02B 27/01

(52) U.S. Cl. CPC G02B 27/0172; G02B 2027/0123

(57) ABSTRACT

The disclosure provides an optical waveguide component and an augmented reality display device. The optical waveguide component comprises: a waveguide substrate and at least one grating group, the grating group comprising a coupling-in grating, a turning grating, and a coupling-out grating, with the turning grating and the coupling-in grating provided on two adjacent surfaces of the waveguide substrate; the coupling-in grating is configured for coupling input light into the waveguide substrate; the turning grating is configured for performing a first pupil expansion; and the coupling-out grating is configured for performing a second pupil expansion.

### CROSS-REFERENCE TO RELATED APPLICATIONS

The present disclosure is a National Stage of International Application No. PCT/CN2022/102030, filed on Jun. 28, 2022, which claims priority to Chinese Patent Application No. 202210575116.2, filed on May 24, 2022, both of which are hereby incorporated by reference in their entireties.

TECHNICAL FIELD Embodiments of the present disclosure relate to the technical field of augmented reality, and particularly to an optical waveguide component and an augmented reality display device.

### BACKGROUND

With the development of technology, augmented reality (AR) display devices, such as AR glasses, are capable of projecting virtual images and real-world images simultaneously into the user's eyes, thereby enabling users to see virtual images superimposed on real-world scenes.

In the prior art, augmented reality display devices typically use various types of waveguides, such as geometric waveguides and diffractive waveguides, to achieve image projection. However, to meet the needs of users with different interpupillary distances, it is necessary to provide a plurality of gratings to ensure that the waveguide can transmit light while also providing light expansion functionality. However, the plurality of gratings occupy a significant amount of space, thereby limiting the design space of the waveguide.

### SUMMARY

An objective of embodiments of the present disclosure is to provide a new technical solution for an optical waveguide component.

According to a first aspect of the present disclosure, an optical waveguide component is provided, which includes: a waveguide substrate and at least one grating group, the grating group including a coupling-in grating, a turning grating, and a coupling-out grating, with the turning grating and the coupling-in grating provided on two adjacent surfaces of the waveguide substrate;
the coupling-in grating is configured for coupling input light into the waveguide substrate, where the input light undergoes total internal reflection within the waveguide substrate and is transmitted to the turning grating;
the turning grating performs pupil expansion on the light that has undergone the total internal reflection within the waveguide substrate in a first direction, and transmits the expanded light to the coupling-out grating through the total internal reflection within the waveguide substrate, wherein the first direction is perpendicular to a direction of emergent light from the turning grating; and
the coupling-out grating is configured for performing pupil expansion on the light transmitted to the coupling-out grating in a second direction and coupling it out, wherein the second direction is a propagation direction of the emergent light from the turning grating.

Optionally, the optical waveguide component includes two grating groups, each of which includes a coupling-in grating, a turning grating, and a coupling-out grating.

Optionally, the coupling-in grating of one of the two grating groups is symmetrically distributed with respect to the coupling-in grating of the other one of the two grating groups; the turning grating of one of the two grating groups is symmetrically distributed with respect to the turning grating of the other one of the two grating groups; the coupling-out grating of one of the two grating groups is symmetrically distributed with respect to the coupling-out grating of the other one of the two grating groups.

Optionally, the coupling-out grating of one of the two grating groups is spliced into a whole with the coupling-out grating of the other one of the two grating groups.

Optionally, the optical waveguide component includes two grating groups, each having its own independent coupling-in grating and turning grating, and the two grating groups share a common coupling-out grating;
wherein the coupling-in grating of one of the two grating groups is symmetrically distributed with respect to the coupling-in grating of the other one of the two grating groups, and the turning grating of one of the two grating groups is symmetrically distributed with respect to the turning grating of the other one of the two grating groups.

Optionally, the coupling-in grating, the turning grating, and the coupling-out grating are all one-dimensional gratings.

Optionally, the optical waveguide component includes two grating groups, each having its own independent turning grating and coupling-out grating, and the two grating groups share a common coupling-in grating, wherein the coupling-in grating is located between the independent coupling-out gratings of the two grating groups;
wherein the turning grating of one of the two grating groups is symmetrically distributed with respect to the turning grating of the other one of the two grating groups, and the coupling-out grating of one of the two grating groups is symmetrically distributed with respect to the coupling-out grating of the other one of the two grating groups.

Optionally, the coupling-in grating is a two-dimensional grating, and the turning grating and the coupling-out grating are both one-dimensional gratings.

Optionally, the coupling-in grating and the coupling-out grating are both provided on the same surface of the waveguide substrate, or the coupling-in grating and the coupling-out grating are respectively provided on opposite surfaces of the waveguide substrate.

According to a second aspect of the present disclosure, an augmented reality display device is provided, which includes the optical waveguide component according to the first aspect of the present disclosure.

Optionally, the optical waveguide component includes:
a waveguide substrate with a first region, a second region, and a third region located between the first region and the second region;
two grating groups, each having its own independent turning grating and coupling-out grating, and the two grating groups share a common coupling-in grating; wherein the coupling-in grating is located in the third region, two coupling-out gratings corresponding to the two grating groups are respectively provided in the first region and the second region, and two turning gratings corresponding to the two grating groups are respectively provided in the first region and the second region.

According to embodiments of the present disclosure, the optical waveguide component includes the waveguide substrate and at least one grating group, the grating group including the coupling-in grating, the turning grating, and the coupling-out grating; the coupling-in grating couples input light into the waveguide substrate, where the input light undergoes total internal reflection within the waveguide substrate and is transmitted to the turning grating; the turning grating performs pupil expansion on the light that has undergone the total internal reflection within the waveguide substrate in a first direction, and transmits the expanded light to the coupling-out grating through the total internal reflection within the waveguide substrate; and the coupling-out grating performs pupil expansion on the received light in a second direction and coupling it out. In this way, the present embodiment achieves two-dimensional pupil expansion using the turning grating, making it suitable for users with different interpupillary distances. Moreover, the turning grating and the coupling-in grating are provided on two adjacent surfaces of the waveguide substrate, which reduces the area occupied by the grating region, significantly saving the design space of the waveguide, and thus improving the transmittance of environmental light when using the augmented reality display device.

Other features and advantages of the present disclosure will become apparent from the following detailed description of exemplary embodiments of the present disclosure with reference to the accompanying drawings.

### BRIEF DESCRIPTION OF THE DRAWINGS

In order to more clearly illustrate embodiments of the present disclosure or technical solutions in the prior art, the accompanying drawings needed for description of the embodiments or the prior art will be briefly introduced below. Obviously, drawings described below are only a part of drawings of the present disclosure. For those skilled in the art, other drawings can also be obtained according to the disclosed drawings without creative efforts.

FIG. 1 is a first structural diagram of an optical waveguide component according to an embodiment of the present disclosure;

FIG. 2 is a top view of the optical waveguide component according to an embodiment of the present disclosure;

FIG. 3 is a principal diagram of pupil expansion by a turning grating according to an embodiment of the present disclosure;

FIG. 4 is a K-space schematic diagram of a diffractive optical waveguide according to an embodiment of the present disclosure;

FIG. 5 is a second structural diagram of the optical waveguide component according to an embodiment of the present disclosure;

FIG. 6 is a third structural diagram of the optical waveguide component according to an embodiment of the present disclosure;

FIG. 7 is a fourth structural diagram of the optical waveguide component according to an embodiment of the present disclosure;

FIG. 8 is a fifth structural diagram of the optical waveguide component according to an embodiment of the present disclosure;

FIG. 9 is a sixth structural diagram of the optical waveguide component according to an embodiment of the present disclosure;

FIG. 10 is a front view of an augmented reality glasses according to an embodiment of the present disclosure.

### DESCRIPTION OF REFERENCE SIGNS

waveguide substrate 10, first surface 11, third surface 12, fourth surface 13;
grating group 20; first grating group 20a; second grating group 20b;
coupling-in grating 21, first coupling-in grating 21a, second coupling-in grating 21b; turning grating 22, first turning grating 22a, second turning grating 22b; coupling-out grating 23, first coupling-out grating 23a, second coupling-out grating 23b;
augmented reality glasses 30; frame 31; first region 32; second region 33; third region 34.

### DETAILED DESCRIPTION

Various exemplary embodiments of the present disclosure will now be described in detail with reference to the accompanying drawings. It should be noted that the relative arrangements, numerical expressions, and values of the components and steps set forth in these embodiments do not limit the scope of the present disclosure unless otherwise specifically stated.

The following description of at least one exemplary embodiment is in fact merely illustrative and is in no way intended as a limitation to the present disclosure and its application or use.

Technologies, methods and devices known to those of ordinary skill in the related field may not be discussed in detail; however, the technologies, methods and devices should be regarded as a part of the specification where appropriate.

In all examples shown and discussed herein, any specific value should be interpreted as merely exemplary rather than a limitation. Therefore, other examples of the exemplary embodiments may have different values.

It should be noted that similar reference numerals and letters represent similar items in the accompanying drawings below. Therefore, once an item is defined in one drawing, it is unnecessary to further discuss the item in the subsequent drawings.

Various embodiments and examples according to the present disclosure are described below with reference to the accompanying drawings.

### Embodiments of Optical Waveguide Component

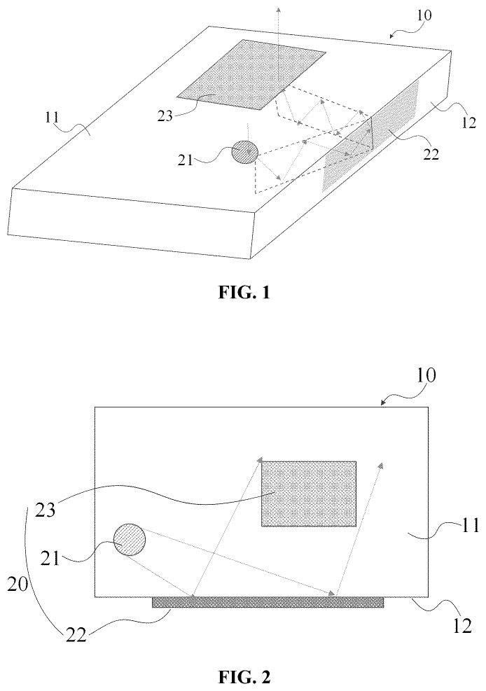

Please refer to FIGS. 1 and 2, embodiments of the present disclosure provide an optical waveguide component. The optical waveguide component includes a waveguide substrate 10 and at least one grating group 20, the grating group 20 includes a coupling-in grating 21, a turning grating 22, and a coupling-out grating 23, and the turning grating 22 and the coupling-in grating 21 are provided on two adjacent surfaces of the waveguide substrate 10. The coupling-in grating 21 is configured for coupling input light into the waveguide substrate 10, where the input light undergoes total internal reflection within the waveguide substrate 10 and is transmitted to the turning grating 22. The turning grating 22 performs pupil expansion on the light that has undergone the total internal reflection within the waveguide substrate 10 in a first direction, and transmits the expanded light to the coupling-out grating 23 through the total internal reflection within the waveguide substrate 10, wherein the first direction is perpendicular to a direction of emergent light from the turning grating 22. The coupling-out grating 23 is configured for performing pupil expansion on the light transmitted to the coupling-out grating 23 in a second direction and coupling it out, wherein the second direction is a propagation direction of the emergent light from the turning grating 22.

In the present embodiment, the waveguide substrate 10 is a light guide device of a diffractive optical waveguide, and is capable of conducting light. The waveguide substrate 10 may be a carrier of the coupling-in grating 21, the turning grating 22, and the coupling-out grating 23. Alternatively, the waveguide substrate 10 may be made of one or more of glass, silicon, plastic, and polymer, and may have a thickness of 0.5 mm to 1 mm.

In an embodiment, the coupling-in grating and the coupling-out grating are both provided on the same surface of the waveguide substrate, or the coupling-in grating and the coupling-out grating are respectively provided on opposite surfaces of the waveguide substrate.

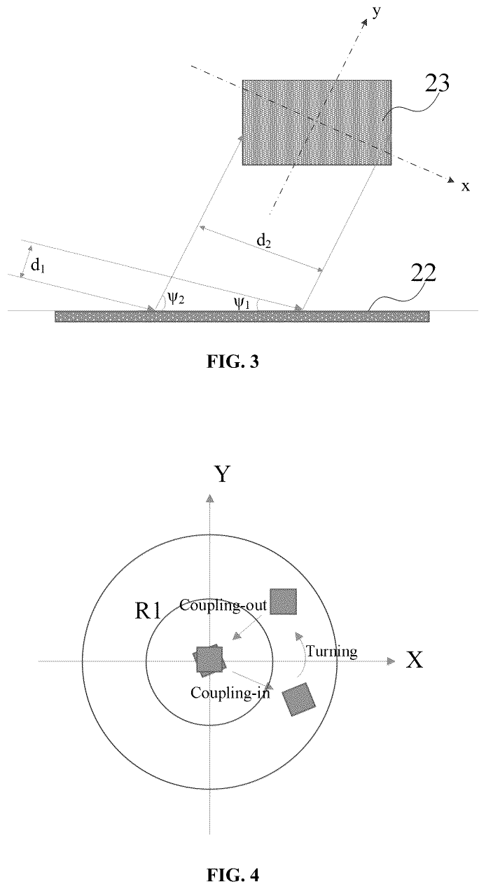

Please refer to FIG. 2, in the working process of the diffractive optical waveguide, light is projected onto the coupling-in grating 21, the coupling-in grating 21 couples the light into the waveguide substrate 10, the input light undergoes total internal reflection within the waveguide substrate 10 and is transmitted to the turning grating 22, and the turning grating 22 modulates the light, so as to perform pupil expansion on the light that has undergone the total internal reflection within the waveguide substrate 10 in a first direction, and to transmit the expanded light to the coupling-out grating 23 through the total internal reflection within the waveguide substrate 10. After that, the coupling-out grating 23 performs another pupil expansion on the light in a second direction and couples the light out of the waveguide substrate 10. Here, the first direction is perpendicular to the emergent light from the turning grating 22, for example, the x-direction shown in FIG. 3. The second direction is the propagation direction of the emergent light from the turning grating 22, for example, the y-direction shown in FIG. 3.

The working principle provided by the present embodiment is described below with reference to FIGS. 3 and 4.

Please refer to FIG. 3, it shows a principal diagram of pupil expansion by the turning grating. Specifically, taking the propagation path of parallel light shown in the figure as an example, the azimuth angle of the light transmitted from the coupling-in grating 21 to the turning grating 22 is ψ₁. After modulation by the turning grating 22, the azimuth angle of the light transmitted from the turning grating 22 to the coupling-out grating 23 is ψ₂. The beam diameter expands from d₁ to d₂, meaning that before modulation by the turning grating 22, the diameter of the light transmitted from the coupling-in grating 21 to the turning grating 22 is d₁, and after modulation by the turning grating 22, the diameter of the light transmitted from the turning grating 22 to the coupling-out grating 23 is d₂. Due to the modulation effect of the turning grating 22, the azimuth angle ψ₂ of the light transmitted from the turning grating 22 to the coupling-out grating 23 is greater than the azimuth angle ψ₁of the light transmitted from the coupling-in grating 21 to the turning grating 22, such that the beam diameter d₂ of light transmitted from the turning grating 22 to the coupling-out grating 23 is larger than the beam diameter d₁ of the light transmitted from the coupling-in grating 21 to the turning grating 22, thus achieving pupil expansion in the first direction (i.e., the x-direction in the figure).

Please refer to FIG. 4, it is a K-space schematic diagram of the diffractive optical waveguide provided by embodiments of the present disclosure. Specifically, K-space may be represented as a polar coordinate of the incident angle θ and the azimuth angle ψ, wherein the horizontal coordinate is sinθcosψ and the vertical coordinate is sinθsinψ. An angle between a line connecting a point in this coordinate system to the origin and the X-axis represents the azimuth angle ψ of the light propagation. In K-space, the light entering the waveguide substrate from the coupling-in grating undergoes the total internal reflection and is transmitted to the turning grating through the total internal reflection within the waveguide substrate. The modulation effect of the turning grating on the light is a central rotation, rather than a translation to the light by the coupling-in grating and the coupling-out grating. Afterward, the emergent light from the turning grating undergoes total internal reflection within the waveguide substrate and is transmitted to the coupling-out grating, and the latter couples the light out of the waveguide substrate. In this way, the radial distance of the light vector before and after modulation by the turning grating remains unchanged, while the direction of the azimuth angle of the light vector before and after modulation by the turning grating has been changed. That is, the turning grating only changes the azimuth angle of the light propagation without changing the total internal reflection angle, thereby achieving the function of pupil expansion.

According to embodiments of the present disclosure, the optical waveguide component includes the waveguide substrate and at least one grating group. The grating group includes the coupling-in grating, the turning grating, and the coupling-out grating. The coupling-in grating couples input light into the waveguide substrate, where the input light undergoes total internal reflection within the waveguide substrate and is transmitted to the turning grating. The turning grating performs pupil expansion on the light that has undergone the total internal reflection within the waveguide substrate in a first direction, and transmits the expanded light to the coupling-out grating through the total internal reflection within the waveguide substrate. The coupling-out grating performs pupil expansion on the received light in a second direction and coupling it out. In this way, the present embodiment may achieve two-dimensional pupil expansion by using the turning grating, making it suitable for users with different interpupillary distances. Moreover, the turning grating and the coupling-in grating are provided on two adjacent surfaces of the waveguide substrate, which reduces the area occupied by the grating region, significantly saving the design space of the waveguide, and thus improving transmittance of environmental light when using the augmented reality display device.

In the present embodiment, the optical waveguide component may include one grating group or a plurality of grating groups.

Below is a specific embodiment of the optical waveguide component that includes one grating group.

In one embodiment, the optical waveguide component includes a waveguide substrate and one grating group, and the grating group includes the coupling-in grating, the turning grating, and the coupling-out grating.

Exemplarily, as shown in FIGS. 1 and 2, the waveguide substrate 10 may be a rectangular cuboid, but it may also be other shapes, which is not limited in the embodiment of the present disclosure. The waveguide substrate 10 has a first surface 11 and a second surface opposite to each other, as well as a third surface 12 adjacent to the first surface 11. The coupling-in grating 21 and the coupling-out grating 23 are provided on the first surface 11 of the waveguide substrate 10, while the turning grating 22 is provided on the third surface 12 of the waveguide substrate 10. It may be understood herein that the third surface may also be another surface adjacent to the first surface of the waveguide substrate 10, such as a surface opposite to the third surface 12. The coupling-in grating 21 and the coupling-out grating 23 may also be provided on the first surface and the second surface of the waveguide substrate 10, respectively.

In this example, the waveguide substrate 10 may be made of one of more of glass, silicon, plastic, and polymer, and may have a thickness of 0.5 mm to 1 mm.

The coupling-in grating, turning grating, and coupling-out grating are all one-dimensional gratings, such as rectangular gratings, stepped gratings, inclined gratings, blazed gratings, sinusoidal gratings, liquid crystal gratings, polymer gratings, or polymer-dispersed liquid crystal gratings.

The grating periods of the coupling-in grating, turning grating, and coupling-out grating range from 200 nm to 600 nm.

In the present embodiment, by providing the turning grating and the coupling-in grating on two adjacent surfaces of the waveguide substrate, it is possible to reduce the area occupied by the grating region, significantly saving the design space of the waveguide, and thus improving transmittance of environmental light when using the augmented reality display device.

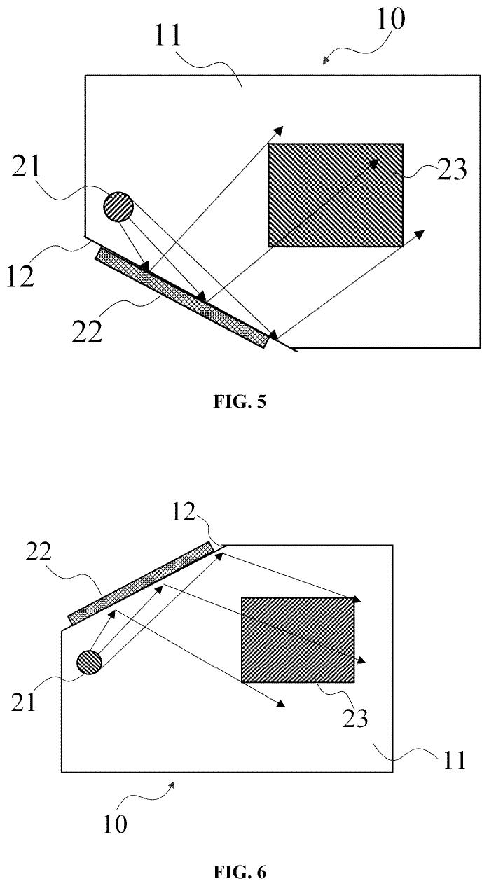

Exemplarily, as shown in FIG. 5 or 6, the waveguide substrate 10 has a notch. The waveguide substrate 10 has a first surface 11 and a second surface opposite to each other, as well as a third surface 12 adjacent to the first surface 11, with the third surface 12 located at the notch of the waveguide substrate. The coupling-in grating 21 and the coupling-out grating 23 are provided on the first surface 11 of the waveguide substrate 10, and the turning grating 22 is provided on the third surface 12 of the waveguide substrate 10. It may be understood that the coupling-in grating 21 and the coupling-out grating 23 may also be provided on the first surface and the second surface of the waveguide substrate 10, respectively.

In this example, the waveguide substrate 10 may be made of one of more of glass, silicon, plastic, and polymer, and may have a thickness of 0.5 mm to 1 mm.

The coupling-in grating, turning grating, and coupling-out grating are all one-dimensional gratings, such as rectangular gratings, stepped gratings, inclined gratings, blazed gratings, sinusoidal gratings, liquid crystal gratings, polymer gratings, or polymer-dispersed liquid crystal gratings.

The grating periods of the coupling-in grating, turning grating, and coupling-out grating range from 200 nm to 600 nm.

In the present embodiment, a plurality of settings of the turning grating are provided, so that during actual implementation, it is possible to design the shape of the waveguide substrate according to actual needs, and to provide the turning grating based on the shape of the optical waveguide substrate, making the layout of the turning grating more flexible. This results in a more flexible and compact design of the optical waveguide component, and further reduces the area occupied by the grating region.

It should be noted that, for any of the embodiments including one grating group mentioned above, the position of the coupling-in grating corresponds to the image source output device of the augmented reality display device. The coupling-out grating corresponds to the user's eye, and the size of the coupling-out grating may be determined according to the field of view angle of the optical waveguide component, the wavelength of the incident light, the user's interpupillary distance, and the distance from the optical waveguide component to the user's eye. The positional relationship between the coupling-in grating, turning grating, and coupling-out grating should ensure that the diameter of the light transmitted from the turning grating to the coupling-out grating is greater than the diameter of the light transmitted from the coupling-in grating to the turning grating.

Below is a specific embodiment of an optical waveguide component that includes two grating groups.

In one embodiment, the optical waveguide component includes a waveguide substrate and two grating groups, each of which includes a coupling-in grating, a turning grating, and a coupling-out grating, that is, a first grating group 20a and a second grating group 20b. The first grating group 20a includes a first coupling-in grating 21a, a first turning grating 22a, and a first coupling-out grating 23a, and the second grating group 20b includes a second coupling-in grating 21b, a second turning grating 22b, and a second coupling-out grating 23b.

Optionally, the coupling-in grating of one of the two grating groups is symmetrically distributed with respect to the coupling-in grating of the other one of the two grating groups; the turning grating of one of the two grating groups is symmetrically distributed with respect to the turning grating of the other one of the two grating groups; and the coupling-out grating of one of the two grating groups is symmetrically distributed with respect to the coupling-out grating of the other one of the two grating groups.

In the present embodiment, by using the two grating groups, two optical paths may be formed, which may be used to display different images, and may improve the optical efficiency of the optical waveguide component.

Optionally, the coupling-out grating of one of the two grating groups is spliced into a whole with the coupling-out grating of the other one of the two grating groups.

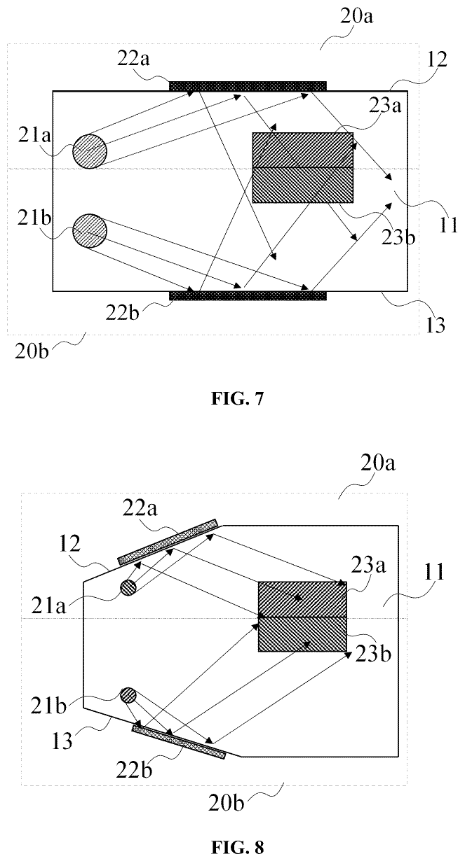

Exemplarily, as shown in FIG. 7, the waveguide substrate may be a rectangular cuboid, and the waveguide substrate has a first surface 11 and a second surface opposite to each other, a third surface 12 adjacent to the first surface 11, and a fourth surface 13 adjacent to the first surface 11. The first coupling-in grating 21a and the first coupling-out grating 23a are provided on the first surface 11, the first turning grating 22a is provided on the third surface 12, the second turning grating 22b is provided on the fourth surface 13, and the second coupling-in grating 21b and the second coupling-out grating 23b are provided on the first surface 11. Here, the first grating group 20a and the second grating group 20b are provided symmetrically, and the first coupling-out grating 23a and the second coupling-out grating 23b are spliced into a whole, serving as a whole coupling-out grating for emitting light. That is to say, the first coupling-in grating 21a and the second coupling-in grating 21b are provided symmetrically, the first turning grating 22a and the second turning grating 22b are provided symmetrically, and the first coupling-out grating 23a and the second coupling-out grating 23b are spliced into a whole, serving as a whole coupling-out grating for emitting images.

In this example, the waveguide substrate 10 may be made of one of more of glass, silicon, plastic, and polymer, and may have a thickness of 0.5 mm to 1 mm.

The first coupling-in grating, the first turning grating, the first coupling-out grating, the second coupling-in grating, the second turning grating, and the second coupling-out grating are all one-dimensional gratings, such as rectangular gratings, stepped gratings, inclined gratings, blazed gratings, sinusoidal gratings, liquid crystal gratings, polymer gratings, or polymer-dispersed liquid crystal gratings.

The grating periods of the first coupling-in grating, the first turning grating, the first coupling-out grating, the second coupling-in grating, the second turning grating, and the second coupling-out grating range from 200 nm to 600 nm.

Exemplarily, as shown in FIG. 8, the waveguide substrate may be a rectangular cuboid, and has a first notch and a second notch which are symmetrically distributed. For example, the first notch is located at the upper left corner of the waveguide substrate, and the second notch is located at the lower left corner of the waveguide substrate. The waveguide substrate has a first surface 11 and a second surface opposite to each other, as well as a third surface 12 adjacent to the first surface 11, and a fourth surface 13 adjacent to the first surface 11, with the third surface 12 located at the first notch, and the third surface 12 located at the second notch. The first coupling-in grating 21a and the first coupling-out grating 23a are provided on the first surface 11, the first turning grating 22a is provided on the third surface 12, the second turning grating 22b is provided on the fourth surface 13, and the second coupling-in grating 21b and the second coupling-out grating 23b are provided on the first surface 11. Here, the first grating group 20a and the second grating group 20b are provided symmetrically, and the first coupling-out grating 23a and the second coupling-out grating 23b are spliced into a whole, serving as a whole coupling-out grating for emitting light. That is to say, the first coupling-in grating 21a and the second coupling-in grating 21b are provided symmetrically, the first turning grating 22a and the second turning grating 22b are provided symmetrically, and the first coupling-out grating 23a and the second coupling-out grating 23b are spliced into a whole, serving as a whole coupling-out grating for emitting light.

In this example, the waveguide substrate may be made of one of more of glass, silicon, plastic, and polymer, and may have a thickness of 0.5 mm to 1 mm.

The first coupling-in grating, the first turning grating, the first coupling-out grating, the second coupling-in grating, the second turning grating, and the second coupling-out grating are all one-dimensional gratings, such as rectangular gratings, stepped gratings, inclined gratings, blazed gratings, sinusoidal gratings, liquid crystal gratings, polymer gratings, or polymer-dispersed liquid crystal gratings.

The grating periods of the first coupling-in grating, the first turning grating, the first coupling-out grating, the second coupling-in grating, the second turning grating, and the second coupling-out grating range from 200 nm to 600 nm.

Taking the optical waveguide component shown in FIGS. 7 and 8 as an example, the working process of the optical waveguide component is as follows: the image to be displayed may be divided into an upper part and a lower part. Here, for the upper part of the image, the corresponding light source can enter the waveguide substrate from the first coupling-in grating 21a, and after undergoing total internal reflection within the waveguide substrate, it is transmitted to the first turning grating 22a located on the third surface 12. The first turning grating 22a modulates the received light, causing the modulated light to undergo total internal reflection within the waveguide substrate and then be transmitted to the first coupling-out grating 23a, through which it is emitted from the waveguide substrate. For the lower part of the image, the corresponding light source can enter the waveguide substrate from the second coupling-in grating 21b, and after undergoing total internal reflection within the waveguide substrate, it is transmitted to the second turning grating 22b located on the fourth surface 13. The second turning grating 22b modulates the received light, causing the modulated light to undergo total internal reflection within the waveguide substrate and then be transmitted to the second coupling-out grating 23b, through which it is emitted from the waveguide substrate. In this way, the light coupled out of the first coupling-out grating 23a and the second coupling-out grating 23b forms the whole image to be displayed.

It should be noted that, for any of the embodiments including two grating groups mentioned above, the positions of the first coupling-in grating and the second coupling-in grating correspond to the image source output device of the augmented reality display device. The first coupling-out grating and the second coupling-out grating are spliced into a whole coupling-out grating to correspond to the user's eye, and the size of the whole coupling-out grating may be determined according to the field of view angle of the optical waveguide component, the wavelength of the incident light, the user's interpupillary distance, and the distance from the optical waveguide component to the user's eye. Furthermore, the positional relationship between the coupling-in grating, turning grating, and coupling-out grating in each grating group should ensure that the diameter of the light transmitted from the turning grating to the coupling-out grating is greater than the diameter of the light transmitted from the coupling-in grating to the turning grating.

In the present embodiment, for light of different wavelengths, the modulation effect of the turning grating is different, and when modulating light of a plurality of wavelengths through a single turning grating, the pupil expansion effect is limited. To address this, the optical waveguide component provided by the present embodiment may include two grating groups, each of which includes a coupling-in grating, a turning grating, and a coupling-out grating, and the two coupling-out gratings of the two grating groups are spliced into a whole coupling-out grating. In this way, the image source may enter the waveguide substrate from the two coupling-in gratings respectively, and be modulated by the corresponding turning gratings respectively so as to be emitted through the corresponding coupling-out gratings, such that the optical waveguide component has a plurality of optical paths, which may reduce the field-of-view pressure on a single light transmission channel, thus improving the uniformity of the emergent light from the optical waveguide component, and improving the optical efficiency of the optical waveguide component. Additionally, the two turning gratings may be provided at the notches of the waveguide substrate, which may further save design space for the waveguide, making the design of the optical waveguide component more flexible.

In one embodiment, the optical waveguide component includes a waveguide substrate and two grating groups, each having its own independent coupling-in grating and turning grating, and the two grating groups share a common coupling-out grating; wherein the coupling-in grating of one of the two grating groups is symmetrically distributed with respect to the coupling-in grating of the other one of the two grating groups, and the turning grating of one of the two grating groups is symmetrically distributed with respect to the turning grating of the other one of the two grating groups.

Taking the optical waveguide component shown in FIGS. 7 and 8 as an example, the coupling-out grating may be a whole coupling-out grating formed by splicing the first coupling-out grating 23a and the second coupling-out grating 23b.

In this example, the waveguide substrate 10 may be made of one of more of glass, silicon, plastic, and polymer, and may have a thickness of 0.5 mm to 1 mm.

The coupling-in grating, turning grating, and coupling-out grating are all one-dimensional gratings, such as rectangular gratings, stepped gratings, inclined gratings, blazed gratings, sinusoidal gratings, liquid crystal gratings, polymer gratings, or polymer-dispersed liquid crystal gratings.

The grating periods of the coupling-in grating, turning grating, and coupling-out grating range from 200 nm to 600 nm.

It should be noted that the positions of the two coupling-in gratings correspond to the image source output device of the augmented reality display device. The coupling-out grating corresponds to the user's eye, and the size of the coupling-out grating may be determined according to the field of view angle of the optical waveguide component, the wavelength of the incident light, the user's interpupillary distance, and the distance from the optical waveguide component to the user's eye. Furthermore, the positional relationship between the coupling-in grating, turning grating, and coupling-out grating in each grating group should ensure that the diameter of the light transmitted from the turning grating to the coupling-out grating is greater than the diameter of the light transmitted from the coupling-in grating to the turning grating.

In the present embodiment, the optical waveguide component may include two grating groups, each having its own independent coupling-in grating and turning grating, and the two grating groups share a common coupling-out grating. In this way, the image source may enter the waveguide substrate from two coupling-in gratings respectively and be modulated by the corresponding turning gratings respectively so as to be emitted through the shared coupling-out grating, such that the optical waveguide component has a plurality of optical paths, which may reduce the field-of-view pressure on a single light transmission channel, thus improving the uniformity of the emergent light from the optical waveguide component, and improving the optical efficiency of the optical waveguide component ..

In one embodiment, the optical waveguide component includes a waveguide substrate and two grating groups, each having its own independent turning grating and coupling-out grating, and the two grating groups share a common coupling-in grating, wherein the coupling-in grating is located between the independent coupling-out gratings of the two grating groups; wherein the turning grating of one of the two grating groups is symmetrically distributed with respect to the turning grating of the other one of the two grating groups, and the coupling-out grating of one of the two grating groups is symmetrically distributed with respect to the coupling-out grating of the other one of the two grating groups.

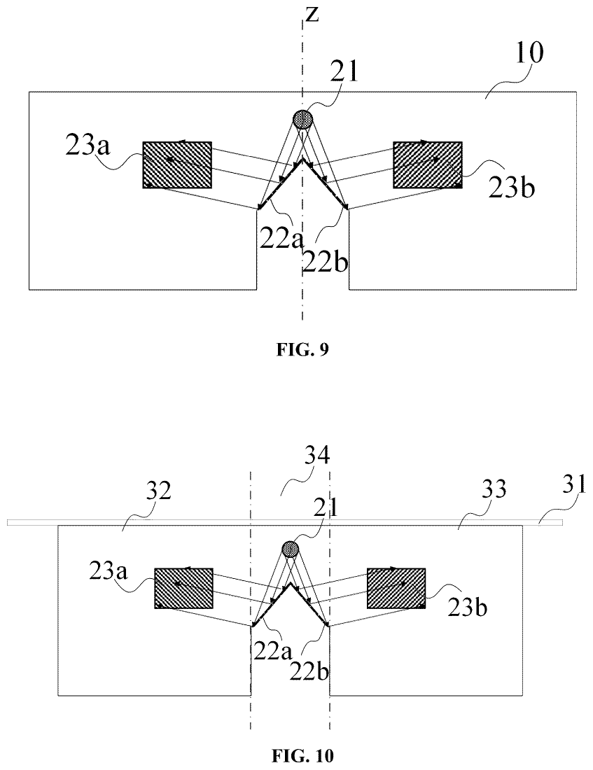

Exemplarily, as shown in FIG. 9, the optical waveguide component includes a waveguide substrate 10 and two grating groups, wherein the two grating groups specifically are a first grating group and a second grating group. The first grating group has an independent first turning grating 22a and an independent first coupling-out grating 23a, and the second grating group has an independent second turning grating 22b and an independent second coupling-out grating 23b. The first grating group and the second grating group share a common coupling-in grating 21. The waveguide substrate has a first surface, and a third surface and a fourth surface both adjacent to the first surface. Here, the coupling-in grating 21, the first coupling-out grating 23a, and the second coupling-out grating 23b are all provided on the first surface of the waveguide substrate, the first turning grating 22a is provided on the third surface of the waveguide substrate, the second turning grating 22b is provided on the fourth surface of the waveguide substrate, and the coupling-in grating 21 is located between the first coupling-out grating 23a and the second coupling-out grating 23b. In addition, the first coupling-out grating 23a and the second coupling-out grating 23b are symmetrically distributed about the z-axis where the coupling-in grating 21 is located, and the first turning grating 22a and the second turning grating 22b are symmetrically distributed about the z-axis where the coupling-in grating 21 is located.

In this example, the optical waveguide component may be used in augmented reality glasses.

The waveguide substrate may be made of one of more of glass, silicon, plastic, and polymer, and may have a thickness of 0.5 mm to 1 mm.

The coupling-in grating may be a two-dimensional grating, such as a square grating, a rectangular grating, a parallelogram grating, or a rhombic grating. The coupling-in grating may also be a double-sided one-dimensional grating.

The first turning grating, the first coupling-out grating, the second turning grating, and the second coupling-out grating are all one-dimensional gratings, such as rectangular gratings, stepped gratings, inclined gratings, blazed gratings, sinusoidal gratings, liquid crystal gratings, polymer gratings, or polymer-dispersed liquid crystal gratings.

The grating periods of the coupling-in grating, the first turning grating, the first coupling-out grating, the second turning grating, and the second coupling-out grating range from 200 nm to 600 nm.

The working process of the optical waveguide component is as follows: the image source may enter the waveguide substrate from the coupling-in grating 21, and the light entering the waveguide substrate is divided into a first part and a second part of the light. The first part of the light undergoes total internal reflection within the waveguide substrate and is transmitted to the first turning grating 22a located on the third surface 12. The first turning grating 22a modulates the received light, such that the modulated light undergoes total internal reflection within the waveguide substrate and is transmitted to the first coupling-out grating 23a, and after that, it is emitted from the waveguide substrate through the first coupling-out grating 23a. The second part of the light undergoes total internal reflection within the waveguide substrate and is transmitted to the second turning grating 22b located on the fourth surface 13, and the second turning grating 22b modulates the received light, such that the modulated light undergoes total internal reflection within the waveguide substrate and is transmitted to the second coupling-out grating 23b, and after that, it is emitted from the waveguide substrate through the second coupling-out grating 23b. In this way, the light coupled out of the first coupling-out grating 23a and the second coupling-out grating 23b may generate the same image.

It should be noted that the position of the coupling-in grating corresponds to the image source output device of the augmented reality display device. The first coupling-out grating and the second coupling-out grating correspond to the user's eyes respectively, and the size of the first coupling-out grating and the second coupling-out grating may be determined according to the field of view angle of the optical waveguide component, the wavelength of the incident light, the user's interpupillary distance, and the distance from the optical waveguide component to the user's eye. Furthermore, the positional relationship between the coupling-in grating, turning grating, and coupling-out grating in each grating group should ensure that the diameter of the light transmitted from the turning grating to the coupling-out grating is greater than the diameter of the light transmitted from the coupling-in grating to the turning grating.

In the present embodiment, the optical waveguide component may include two grating groups, and the optical waveguide component includes two grating groups, each having its own independent turning grating and coupling-out grating, and the two grating groups share a common coupling-in grating. The optical waveguide component may be used for binocular waveguide lenses, and the two coupling-out gratings corresponding to the binocular waveguide lens may share a common coupling-in grating, which may reduce the space occupied by the grating and reduce the weight of the augmented reality display device, thereby contributing to a lightweight design of the augmented reality display device.

### Embodiments of Device

The present embodiment provides an augmented reality display device, which includes the optical waveguide component described in any of the preceding embodiments.

In the present embodiment, the optical waveguide component may be the optical waveguide component described in any of the preceding embodiments. For example, the optical waveguide component may be a diffractive optical waveguide.

For example, the augmented reality display device may be augmented reality glasses.

In one embodiment, the optical waveguide component includes a waveguide substrate and two grating groups. The waveguide substrate has a first region, a second region, and a third region located between the first region and the second region. Each of the two grating groups has its own independent turning grating and coupling-out grating, and the two grating groups share a common coupling-in grating; wherein the coupling-in grating is located in the third region, two coupling-out gratings corresponding to the two grating groups are respectively provided in the first region and the second region, and two turning gratings corresponding to the two grating groups are respectively provided in the first region and the second region.

Exemplarily, the first region and the second region of the waveguide substrate are symmetrically distributed.

Please refer to FIG. 10, taking augmented reality glasses as an example, the augmented reality glasses 30 include a frame 31 and the optical waveguide component, and the frame has two spaced-apart viewing areas. The optical waveguide component includes a waveguide substrate and two grating groups, the waveguide substrate is fixed on the frame 31, and the waveguide substrate has a first region 32 and a second region 33 that match the two viewing areas respectively, as well as a third region 34 located between the first region 32 and the second region 33; each of the two grating groups has its own independent turning grating and coupling-out grating, and the two grating groups share a common coupling-in grating; wherein the coupling-in grating is located in the third region 34, the two coupling-out gratings corresponding to the two grating groups are provided in the first region 32 and the second region 33, respectively, and the two turning gratings corresponding to the two grating groups are provided in the first region 32 and the second region 33, respectively.

Specifically, as shown in FIG. 10, the first region 32 has a fifth surface facing towards the user, the second region 33 has a sixth surface facing towards the user, the third region 34 has a seventh surface facing towards the user and two sides adjacent to the seventh surface, and when the augmented reality glasses are worn, these two sides respectively face towards the wearer's nostrils on either side.

The two grating groups are specifically the first grating group and the second grating group. The first grating group has an independent first turning grating 22a and an independent first coupling-out grating 23a, and the second grating group has an independent second turning grating 22b and an independent second coupling-out grating 23b. The first grating group and the second grating group share a common coupling-in grating 21. Here, the coupling-in grating 21 is provided on the seventh surface of the third region 34 facing towards the user, the first coupling-out grating 23a is provided on the fifth surface of the first region 32 facing towards the user, and the first turning grating 22a is provided on a side of the third region 34 facing towards one of the wearer's nostrils. The second coupling-out grating 23b is provided on the sixth surface of the second region 33 facing towards the user, and the second turning grating 22b is provided on a side of the third region 34 facing towards the other of the wearer's nostrils. Moreover, the first coupling-out grating 23a and the second coupling-out grating 23b are symmetrically distributed, and the first turning grating 22a and the second turning grating 22b are symmetrically distributed.

Continuing taking the example of augmented reality glasses as an example, the working process of the augmented reality display device is as follows: the image source may enter the waveguide substrate through the coupling-in grating 21, and the light entering the waveguide substrate is divided into a first part and a second part. The first part of the light undergoes total internal reflection within the waveguide substrate and is transmitted to the first turning grating 22a located on a side of the third region 34 facing towards one of the wearer's nostrils. The first turning grating 22a modulates the received light, such that the modulated light undergoes total internal reflection within the waveguide substrate and is transmitted to the first coupling-out grating 23a located in one of the viewing areas, and after that, it is emitted from the waveguide substrate through the first coupling-out grating 23a; the second part of the light undergoes total internal reflection within the waveguide substrate and is transmitted to the second turning grating 22b located on a side of the third region 34 facing towards the other of the wearer's nostrils. The second turning grating 22b modulates the received light, such that the modulated light undergoes total internal reflection within the waveguide substrate and is transmitted to the second coupling-out grating 23b located in the other viewing area, and after that, it is emitted from the waveguide substrate through the second coupling-out grating 23b. In this way, the light coupled out of the first coupling-out grating 23a and the second coupling-out grating 23b may generate the same virtual image, meaning that the wearer's both eyes may see the same virtual image.

According to embodiments of the present disclosure, the augmented reality display device includes an optical waveguide component, which includes a waveguide substrate and at least one grating group. The grating group includes a coupling-in grating, a turning grating, and a coupling-out grating. The coupling-in grating couples input light into the waveguide substrate, where the input light undergoes total internal reflection within the waveguide substrate and is transmitted to the turning grating. The turning grating performs pupil expansion on the light that has undergone the total internal reflection within the waveguide substrate in a first direction, and transmits the expanded light to the coupling-out grating through the total internal reflection within the waveguide substrate. The coupling-out grating performs pupil expansion on the received light in a second direction and coupling it out. In this way, the present embodiment can achieve two-dimensional pupil expansion using the turning grating, thereby accommodating users with different interpupillary distances. Moreover, the turning grating and the coupling-in grating are provided on two adjacent surfaces of the waveguide substrate, which may reduce the area occupied by the grating region, significantly saving the design space of the waveguide, and thus improving transmittance of environmental light when using the augmented reality display device.

In addition, in a case where the optical waveguide component includes two grating groups, each of the two grating groups has its own independent turning grating and coupling-out grating, and the two grating groups share a common coupling-in grating. The optical waveguide component may be used for binocular waveguide lenses, and the two coupling-out gratings corresponding to the binocular waveguide lens may share a common coupling-in grating, which may reduce the space occupied by the grating and reduce the weight of the augmented reality display device, thereby contributing to a lightweight design of the augmented reality display device.

In the description of the present specification, the reference terms “one embodiment”, “some embodiments”, “illustrative embodiment”, “example”, “specific example”, or “some examples” are intended to indicate that specific features, structures, materials, or characteristics described in connection with the embodiment or example are included in at least one embodiment or example of the present disclosure. In the present specification, the illustrative expressions of the above terms do not necessarily refer to the same embodiment or example. Furthermore, the specific features, structures, materials, or characteristics described may be combined in any one or more embodiments or examples in a suitable manner.

Although embodiments of the present disclosure have been shown and described, it will be understood by those skilled in the art that various changes, modifications, substitutions, and variations may be made to these embodiments without departing from the principles and purpose of the present disclosure, the scope of which is defined by the claims and their equivalents.

The various embodiments of the present disclosure have been described above. The foregoing description is illustrative and not exhaustive, and is not limited to the disclosed embodiments. Many modifications and variations will be apparent to those of ordinary skill in the art without departing from the scope and spirit of the described embodiments. The choice of terminology used herein is intended to best explain the principles of the embodiments, their practical application, or technical improvements in the market, or to enable others of ordinary skill in the art to understand the embodiments disclosed herein. The scope of the present disclosure is defined by the appended claims.

1. An optical waveguide component, comprising: a waveguide substrate and at least one grating group, the grating group comprising a coupling-in grating, a turning grating, and a coupling-out grating, with the turning grating and the coupling-in grating provided on two adjacent surfaces of the waveguide substrate;
the coupling-in grating is configured for coupling input light into the waveguide substrate, where the input light undergoes a first total internal reflection within the waveguide substrate and is transmitted to the turning grating;
the turning grating is configured for performing a first pupil expansion on the input light that has undergone the first total internal reflection within the waveguide substrate in a first direction, and transmitting expanded light to the coupling-out grating through a second total internal reflection within the waveguide substrate, wherein the first direction is perpendicular to a direction of emergent light from the turning grating; and
the coupling-out grating is configured for performing a second pupil expansion on the expanded light transmitted to the coupling-out grating in a second direction and coupling out the expanded light, wherein the second direction is a propagation direction of the emergent light from the turning grating.

2. The optical waveguide component according to claim 1, comprising a first grating group and a second grating group, each of which comprises a coupling-in grating, a turning grating, and a coupling-out grating.

3. The optical waveguide component according to claim 2, wherein
the coupling-in grating of the first grating groups is symmetrically distributed with respect to the coupling-in grating of the second grating group;
the turning grating of the first grating groups is symmetrically distributed with respect to the turning grating of the second grating group; and
the coupling-out grating of the first grating groups is symmetrically distributed with respect to the coupling-out grating of the second grating groups.

4. The optical waveguide component according to claim 3, wherein the coupling-out gratings of the first grating group and second grating group are configured for forming a whole structure.

5. The optical waveguide component according to claim 1, comprising a first grating group and a second grating group, each having an independent coupling-in grating and turning grating, and sharing a coupling-out grating;
wherein the coupling-in grating of the first grating group is symmetrically distributed with respect to the coupling-in grating of the second grating group, and the turning grating of the first grating group is symmetrically distributed with respect to the turning grating of the second grating groups.

6. The optical waveguide component according to claim 2, wherein the coupling-in grating, the turning grating, and the coupling-out grating are all one-dimensional gratings.

7. The optical waveguide component according to claim 1, comprising a first grating group and a second grating group, each having an independent turning grating and coupling-out grating, and sharing a coupling-in grating, wherein the coupling-in grating is located between the independent coupling-out gratings;
wherein the turning grating of the first grating group is symmetrically distributed with respect to the turning grating of the second grating groups, and the coupling-out grating of the first grating group is symmetrically distributed with respect to the coupling-out grating of the second grating group.

8. The optical waveguide component according to claim 7, wherein the coupling-in grating is a two-dimensional grating, and the turning gratings and the coupling-out gratings of both the first grating group and the second grating group are one-dimensional gratings.

9. The optical waveguide component according to claim 1, wherein the coupling-in grating and the coupling-out grating are both provided on the same surface of the waveguide substrate, or the coupling-in grating and the coupling-out grating are respectively provided on opposite surfaces of the waveguide substrate.

10. An augmented reality display device, comprising an optical waveguide component according to claim 1.

11. The augmented reality display device according to claim 10, wherein the optical waveguide component comprises:
a waveguide substrate with a first region, a second region, and a third region located between the first region and the second region; and
two grating groups, each having an independent turning grating and coupling-out grating, and sharing a common coupling-in grating; wherein the coupling-in grating is located in the third region, two coupling-out gratings of the two grating groups are respectively provided in the first region and the second region, and two turning gratings of the two grating groups are respectively provided in the first region and the second region.
